(19) United States
(12) Patent Application Publication
(10) Pub. No.: US 2004/0011147 A1
(43) Pub. Date: Jan. 22, 2004

(54) Filter soil detecting device

(75) Inventor: Yoshitaka Saida, Wako-shi (JP)

Correspondence Address: MERCHANT & GOULD PC, P.O. BOX 2903, MINNEAPOLIS, MN, 55402-0903, US

(73) Assignee: Honda Giken Kogyo Kabushiki Kaisha, Minato-ku (JP)

(21) Appl. No.: 10/608,675

(22) Filed: Jun. 24, 2003

(30) Foreign Application Priority Data
Jul. 1, 2002 (JP) 2002-192514

(51) Int. Cl. G01M 19/00; B01D 46/42

(52) U.S. Cl. 73/865.9; 96/416

(57) ABSTRACT

A filter soil detecting device includes a chamber provided in communication with an air channel at an air inflow side or outflow side of a filter provided in a pneumatic device. The chamber has a lens and a diaphragm to move toward or away from the lens by pneumatic pressure. The diaphragm has a mark on the surface opposite to the lens. The diaphragm moves toward or away from the lens by pressure variation at the air inflow side or outflow side of the filter, so that the image of the mark seen from the outside of the lens is varied to allow the determination of degree of soiling of the filter.

### FIELD OF THE INVENTION

The present invention relates to filter soil detecting devices for detecting clogging or soiling of filters in pneumatic equipment.

### BACKGROUND OF THE INVENTION

Filters in pneumatic equipment cannot generally be checked from outside for clogging or soiling. A device attached for indicating clogging or soiling of a filter is thus usable to be soon aware of the time to replace the filter. As such a filter soil detecting device, a “Clogging Detecting Device” in Japanese Patent Laid-Open Publication No. 2000-254431, for example, is known.

The above clogging detecting device will be described with reference to FIGS. 10 and 11 hereof.

Referring to FIGS. 10 and 11, a filter soil detecting device 100 includes a clogging detection shaft 103 having a permanent magnet 102 slidably fitted in a main block 101, a primary diaphragm chamber 105 formed by attaching a primary diaphragm 104 to one end of the main block 101, the primary diaphragm chamber 105 being connected to a primary port 107 of a filter 106 shown in FIG. 11, and a secondary diaphragm chamber 115 formed by attaching a secondary diaphragm 114 to the other end of the main block 101, the secondary diaphragm chamber 115 being connected to a secondary port 117 of the filter 106 shown in FIG. 11.

When a filter element 118 of the filter 106 is clogged, the differential pressure between the primary port 107 and secondary port 117 increases, causing the clogging detection shaft 103 to move with the primary and secondary diaphragms 104 and 114. A magnetic variation in the permanent magnet 102 provided on the clogging detection shaft 103 is sensed by a magnetic sensor (not shown) to detect filter clogging.

The above filter soil detecting device 100, however, requires a large differential pressure to cause the clogging detection shaft 103 to move, and is not suitable for the detection of clogging or soiling of filters in, for example, vehicle air conditioners in which only relatively small differential pressures are formed. Specifically, it is difficult for the magnetic sensor to sense a magnetic variation in the permanent magnet 102 caused by a slight movement of the clogging detection shaft 103. It is thus difficult to determine the state of clogging or soiling of the filter element 118.

Thus desired is a filter soil detecting device which can operate under a small differential pressure and easily determine the state of clogging or soiling.

### SUMMARY OF THE INVENTION

According to the present invention, there is provided a filter soil detecting device for detecting, when a filter is soiled, decrease in pressure at a secondary side of the filter below normal value or increase in pressure at a primary side of the filter above normal value, which detecting device comprises: a chamber provided in communication with a channel at the primary side or secondary side of the filter; a lens mounted on the distal end of the chamber; a diaphragm extended in the chamber in parallel with the lens; a mark provided on the surface of the diaphragm opposite to the lens; and a vent provided between the diaphragm and the lens; in which, the diaphragm moves toward or away from the lens by pressure at the primary side or secondary side of the filter, varying the image of the mark seen through the lens from outside, thereby allowing the detection of degree of soiling of the filter.

Thus, in this invention, the diaphragm's moving toward or away from the lens by pressure at the primary or secondary side of the filter is utilized to vary the image of the mark seen through the lens from outside, thereby to detect degree of soiling of the filter.

The diaphragm can quickly move under pressure at the primary or secondary side of the filter and the mark thereon can move with the movement of the diaphragm. The configuration to monitor the mark though the lens allows variation in the image of the mark to be noticed even under small differential pressures.

As a result, the state of clogging or soiling of the filter can be easily determined and clogging or soiling of the filter can be checked under small differential pressures.

In this invention, the chamber is preferably provided at the distal end of a connecting pipe which is connected to the channel in a diverging manner, or directly connected to the channel. The direct mounting of the chamber of the filter soil detecting device to the channel can eliminate support members or the like for mounting the chamber.

In this invention, the detecting device preferably further comprises a lens shade covering approximately half the lens. When soil or the like of the filter is visually checked through the lens, the narrowed viewed area of the lens allows quick detection of soil or the like, increasing visibility.

### BRIEF DESCRIPTION OF THE DRAWINGS

Preferred embodiments of the present invention will be described in detail below, by way of example only, with reference to the accompanying drawings, in which:

FIG. 1 is a cross-sectional view of a pneumatic device and a filter soil detecting device according to a first embodiment of the present invention;

FIGS. 2A, 2B and 2C are diagrams illustrating pressures in an air channel and movements of a diaphragm when a fan is rotated at a maximum volume of air in the filter soil detecting device of the first embodiment shown in FIG. 1;

FIGS. 3A and 3B are diagrams illustrating difference in the look of a mark when a diaphragm is looked in at from the outside of a lens, between a state of no soiling or clogging of a filter and a state of significant soiling or clogging in the filter soil detecting device of the first embodiment shown in FIG. 1;

FIGS. 4A and 4B are a perspective view illustrating the appearance of the filter soil detecting device shown in FIG. 1 and a diagram illustrating a mark seen from above the lens;

FIGS. 5A and 5B are a perspective view illustrating the appearance of a filter soil detecting device according to a second embodiment and a diagram illustrating a mark seen from above a lens;

FIG. 6 is a cross-sectional view of a filter soil detecting device according to a third embodiment;

FIG. 7 is a cross-sectional view of a filter soil detecting device according to a fourth embodiment;

FIGS. 8A, 8B and 8C are diagrams illustrating pressures in an air channel and movements of a diaphragm when a fan is rotated at a maximum volume of air in the filter soil detecting device of the fourth embodiment;

FIGS. 9A and 9B are diagrams illustrating difference in the look of a mark when a diaphragm is looked in at from the outside of a lens, between a state of no soiling or clogging of a filter and a state of significant soiling or clogging in the filter soil detecting device of the fourth embodiment shown in FIG. 7;

FIG. 10 is a cross-sectional view of a conventional filter soil detecting device; and

FIG. 11 is a cutaway cross-sectional view of a filter equipped with the conventional filter soil detecting device.

### DETAILED DESCRIPTION OF THE PREFERRED EMBODIMENTS

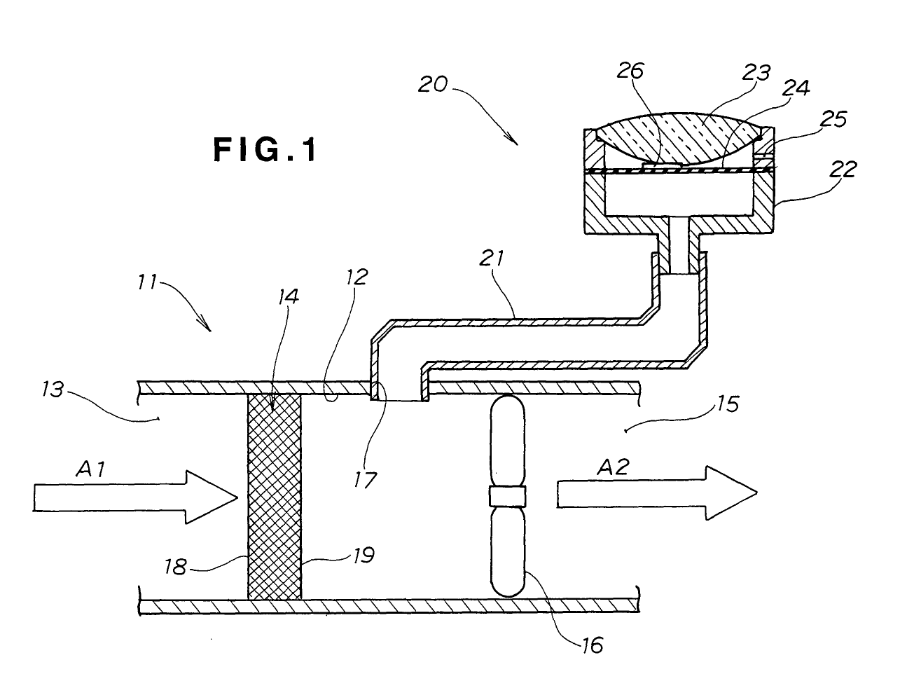

Referring now to FIG. 1, a pneumatic device 11 includes an air channel 12 for guiding air, a filter 14 provided near an inlet 13 of the air channel 12 for removing dust in the air, and a fan 16 provided near an outlet 15 of the air channel 12 for causing air flow. The air channel 12 has a pressure take-off port 17 for taking the pressure of the air channel 12 between the filter 14 and the fan 16.

An air inflow side 18 of the filter 14 is herein defined as a primary side of the filter 14 and an air outflow side 19 of the filter 14 is defined as a secondary side of the filter. Hollow arrow Al indicates the flow of air at the primary side of the filter 14 and hollow arrow A2 indicates the flow of air at the secondary side of the filter 14.

A filter soil detecting device 20 is a device for detecting the state of soiling or clogging of the filter 14 in the pneumatic device 11. The detecting device 20 includes a connecting pipe 21 connected to the pressure take-off port 17 of the air channel 12, a chamber 22 connected to the distal end of the connecting pipe 21, a lens 23 mounted on the distal end of the chamber 22, and a diaphragm 24 extended in the chamber 22 across in parallel with the lens 23. The chamber 22 has a vent 25 provided between the diaphragm 24 and the lens for maintaining atmospheric pressure therebetween. The diaphragm 24 has a mark 26 provided on the surface opposite to the lens 23. The lens 23 is a convex lens.

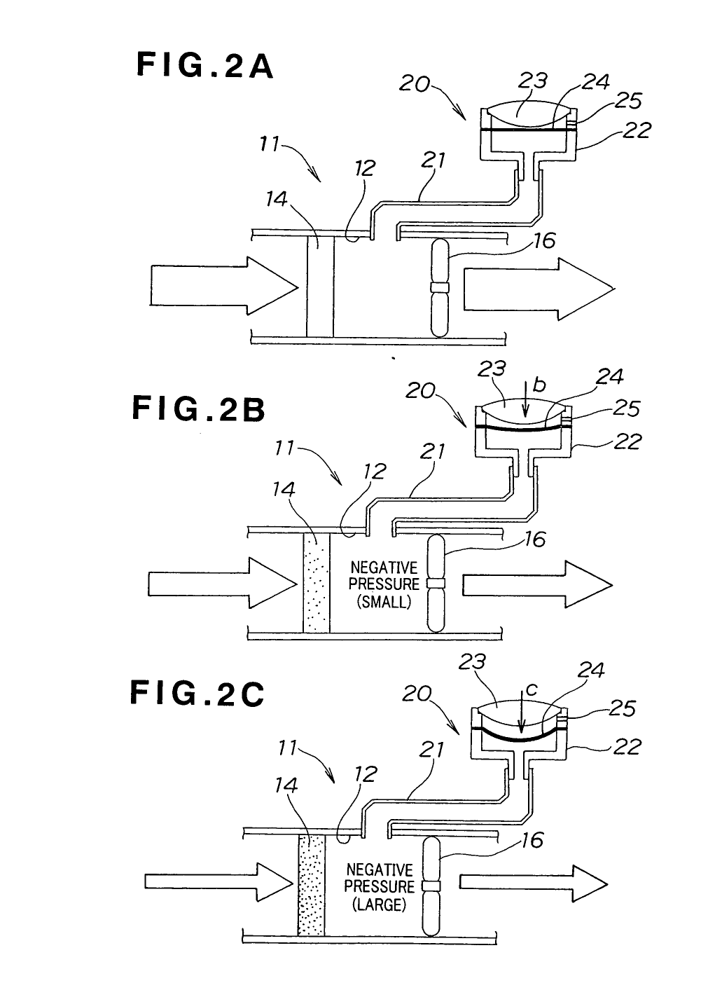

FIGS. 2A, 2B and 2C illustrate pressures in the air channel 12 and movements of the diaphragm 24 when the fan 16 is rotated at a maximum volume of air.

FIG. 2A illustrates a state in which no soiling or clogging of the filter 14 occurs. Pressure at the primary side of the filter 14 and pressure at the secondary side are substantially the same and have normal value. The diaphragm 24 is kept horizontal.

FIG. 2B illustrates a state in which some soiling or clogging of the filter 14 occurs. The pressure at the secondary side of the filter 14 becomes smaller than normal value, forming a small negative pressure. The diaphragm 24 slightly curves as shown by arrow b.

FIG. 2C illustrates a state in which significant soiling or clogging of the filter 14 occurs. The pressure at the secondary side of the filter 14 further becomes smaller than normal value, forming a large negative pressure. The diaphragm 24 largely curves as shown by arrow c.

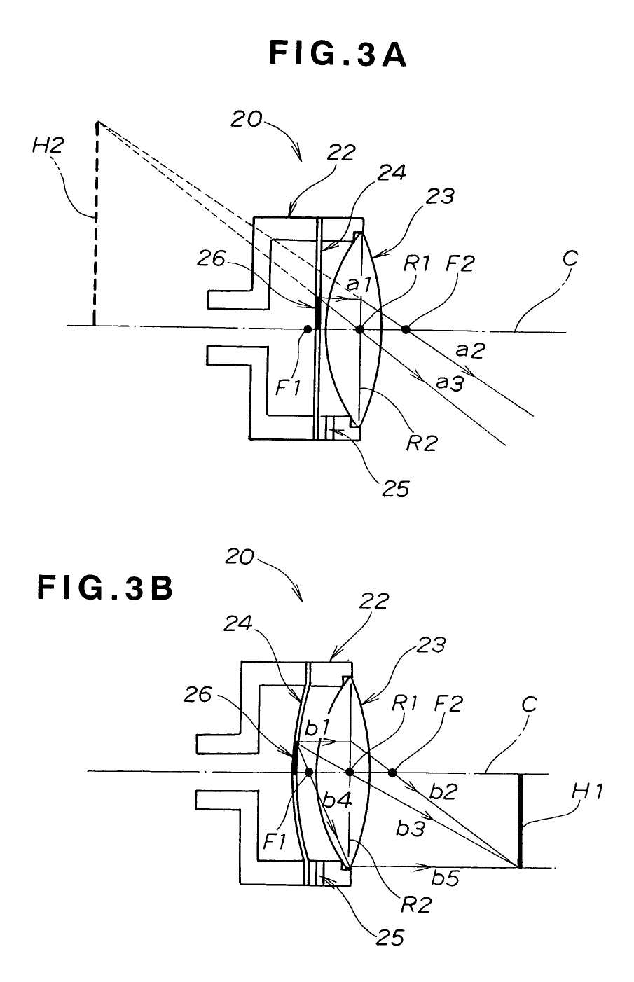

FIGS. 3A and 3B illustrate difference in the look of the mark 26 when the diaphragm 24 is looked in at from the outside of the lens 23, between a state of no soiling or clogging of the filter 14 (see FIG. 1) and a state of significant soiling or clogging.

In FIG. 3A, with F1 as the focal point on the object side, F2 as the focal point on the image side, C as the optical axis, R1 as the lens principal point, and R2 as the lens principal plane, a plane passing through the lens principal point R1, perpendicular to the optical axis C, light coming from the mark 26 into the lens 23 in parallel with the optical axis C as shown by arrow a1 is refracted at the lens principal plane R2 toward the image-side focal point F2 as shown by arrow a2. Light traveling from the mark 26 toward the lens principal point R1 as shown by arrow a3 travels in straight lines without any refraction.

That is, since the mark 26 is located on the lens 23 side (inside) of the object-side focal point F1, no real image is formed. A mark image (virtual image) H2 is formed at the points of intersection of arrows a2 and a3 extended in the opposite directions. The mark 26 can thus be seen as the mark image H2 from the outside of the lens 23.

In FIG. 3B, light coming from the mark 26 into the lens 23 in parallel with the optical axis C as shown by arrow b1 is refracted at the lens principal plane R2 toward the image-side focal point F2 as shown by arrow b2. Light traveling from the mark 26 toward the lens principal point R1 as shown by arrow b3 travels in straight lines without any refraction. Light coming from the mark 26 through the object-side focal point F1 as shown by arrow b4 is refracted at the lens principal plane R2 to travel in parallel with the optical axis C as shown by arrow b5.

That is, a mark image (real image) H1 is formed at the gathering points of arrows b2, b3 and b5. The mark 26 can thus be seen as the mark image H1 from the outside of the lens 23.

The filter soil detecting device 20 for detecting decrease in pressure at the secondary side of the filter 14 below normal value when the filter 14 (see FIG. 1) soils, which filter soil detecting device 20 including the connecting pipe 21 (see FIG. 1) diverging from the air channel 12 (see FIG. 1) at the secondary side of the filter 14, the chamber 22 provided at the distal end of the connecting pipe 21, the lens 23 mounted on the distal end of the chamber 22, the diaphragm 24 extended in the chamber 22 in parallel with the lens 23, the mark 26 provided on the surface of the diaphragm 24 opposite to the lens 23, and the vent 25 provided between the diaphragm 24 and the lens 23, utilizes the fact that the diaphragm 24 moves away from the lens 23 under the pressure at the secondary side of the filter 14 to vary the mark image (H1, H2) seen through the lens 23 from outside, thereby to allow the detection of degree of soiling of the filter 14.

It is preferable that the state of clogging or soiling of the filter 14 (see FIG. 1) can be easily determined and clogging or soiling of the filter 14 can be checked under small differential pressures.

For the purposes, the connecting pipe 21 (see FIG. 1) is diverged from the channel 12 at the secondary side of the filter 14, the chamber 22 is provided at the distal end of the connecting pipe 21, the lens 23 is mounted on the distal end of the chamber 22, the diaphragm 24 is extended in the chamber 22 in parallel with the lens 23, the mark 26 is provided on the surface of the diaphragm 24 opposite to the lens 23, and the vent 25 is provided between the diaphragm 24 and the lens 23, so as to utilize the fact that the diaphragm 24 moves away from the lens 23 under the pressure at the secondary side of the filter 14 to vary the mark image (H1, H2) seen through the lens 23 from outside, thereby to detect the degree of soiling of the filter 14.

The diaphragm 24 can quickly move under the pressure at the secondary side of the filter 14. The mark 26 thereon can move with the movement of the diaphragm 24. The configuration to monitor the mark 26 through the lens 23 thus allows variation in the mark image (H1, H2) to be noticed even under small differential pressures. As a result, the state of clogging or soiling of the filter 14 can be easily determined.

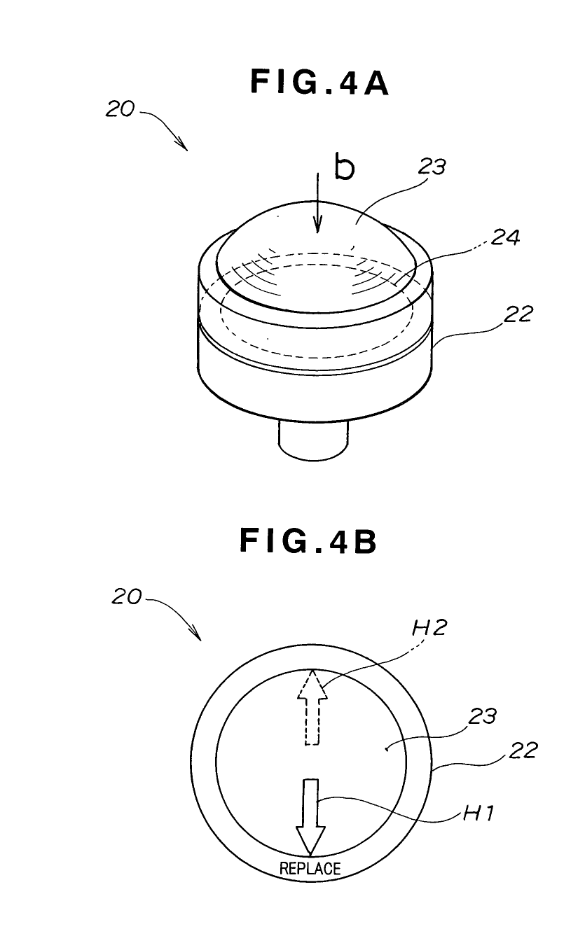

FIGS. 4A and 4B illustrate a perspective view and a plan view of the filter soil detecting device 20 shown in FIG. 1.

When the lens 23 is looked in from above as shown by arrow b in FIG. 4A and the mark image H2 (see FIG. 3A) appears as shown by broken lines in FIG. 4B, it is indicated that no soiling or clogging of the filter 14 (see FIG. 1) occurs.

When the lens 23 is looked in as shown by arrow b and the mark image H1 (see FIG. 3B) can be seen as shown by solid lines in FIG. 4B, it is indicated that significant soiling or clogging of the filter 14 (see FIG. 1) occurs and it is the time to replace or clean the filter 14.

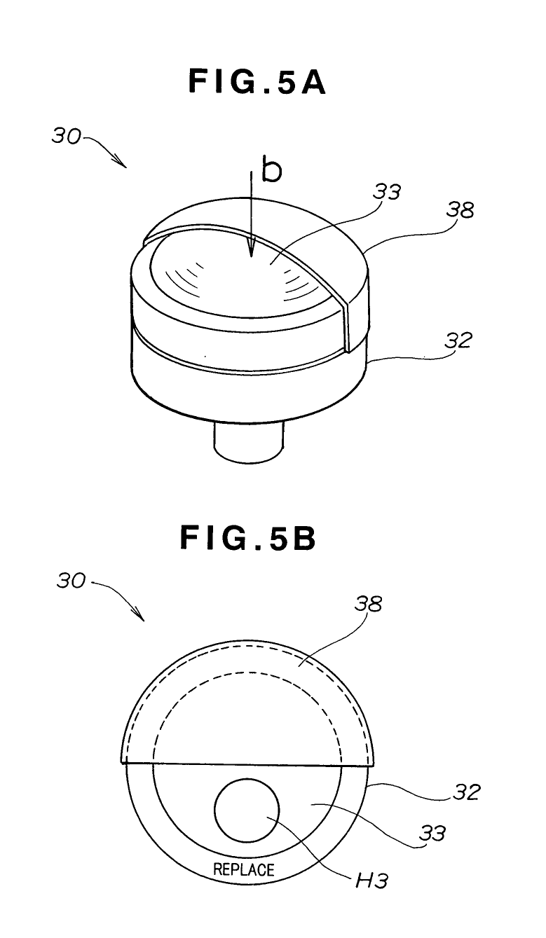

FIGS. 5A and 5B illustrate a filter soil detecting device according to a second embodiment.

A filter soil detecting device 30 in the second embodiment has substantially the same configuration as the filter soil detecting device 20 in the first embodiment shown in FIG. 1, and has a lens shade 38 covering approximately half the exterior of a lens 33, provided on a chamber 32. When the lens 33 is looked in as shown by arrow b and a mark image (real image) H3 as shown in FIG. 5B does not appear, it is indicated that no soiling or clogging of a filter 14 (see FIG. 1) occurs.

When the lens 33 is looked in as shown by arrow b and the mark image H3 can be seen as shown by a solid line in FIG. 5B, it is indicated that substantial soiling or clogging of the filter 14 occurs and it is the time to replace or clean the filter 14.

That is, the lens shade 38 provided to cover about half the lens 33 to narrow the area for indication of soiling or clogging of the filter 14 (see FIG. 1) allows quick determination of soiling or clogging of the filter 14. As a result, the visibility of the filter soil detecting device 30 can be increased.

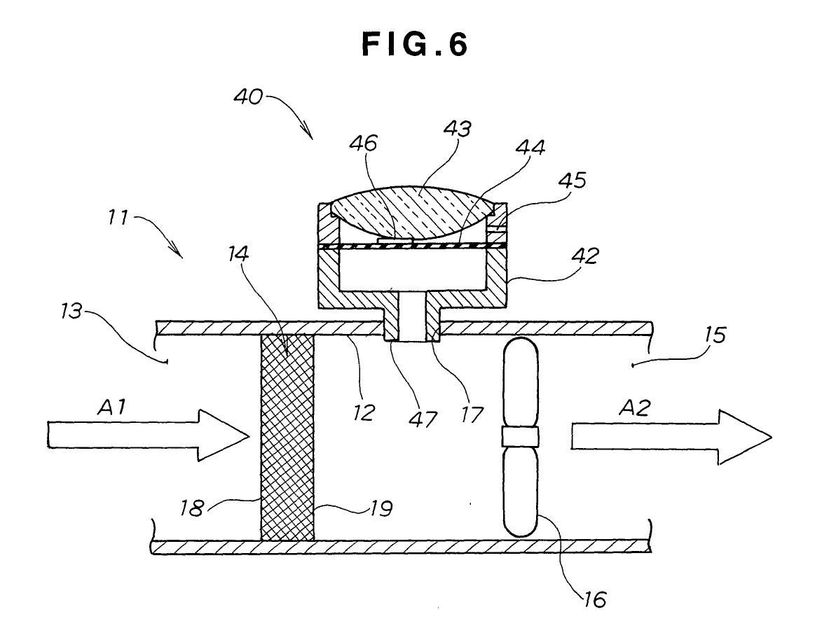

Now, a filter soil detecting device according to a third embodiment of the present invention will be described with reference to FIG. 6. Components identical to those in the filter soil detecting device 20 of the first embodiment shown in FIG. 1 are affixed identical reference numerals and will not be described.

A filter soil detecting device 40 in the third embodiment includes a chamber 42 directly connected to a pressure take-off port 17 of an air channel 12, a lens 42 mounted on the distal end of the chamber 42, and a diaphragm 44 extended in the chamber 42 in parallel with the lens 43.

The chamber 42 has an inlet 47 as a connecting pipe for introducing the pressure of the air channel 12, and a vent 45 provided between the diaphragm 44 and the lens 43 for maintaining atmospheric pressure therebetween. The diaphragm 44 has a mark 46 provided on the surface opposite to the lens 43.

The filter soil detecting device 40 can eliminate supporting members or the like for mounting the chamber 42 by directly mounting the chamber 42 on the pressure take-off port 17 of the air channel 12. The elimination results in reduced costs of the filter soil detecting device 40.

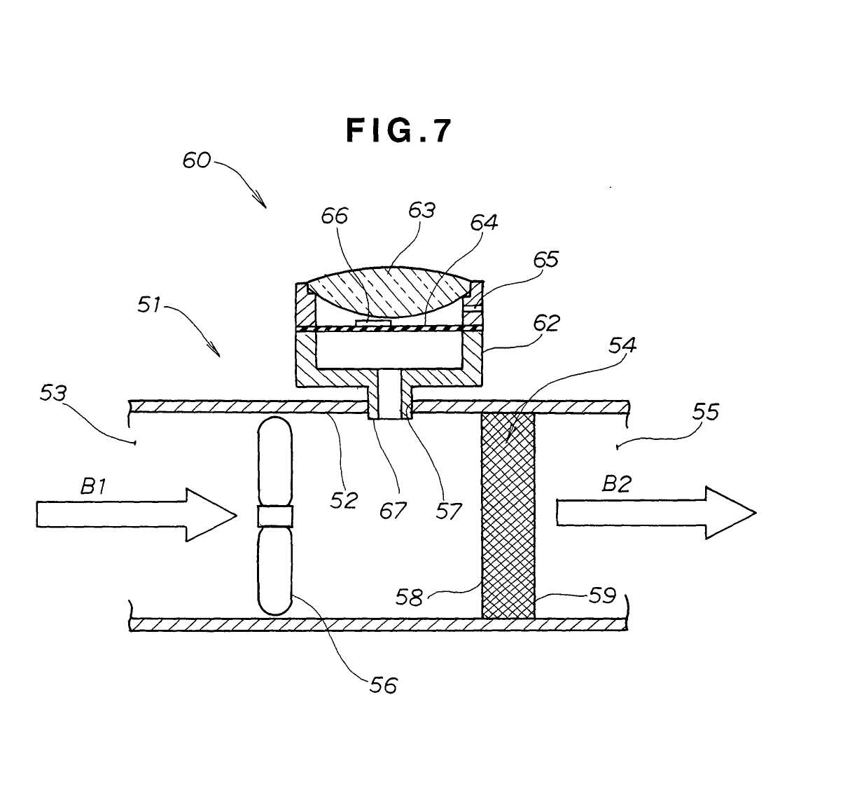

FIGS. 7 to 9B illustrate a filter soil detecting device according to a fourth embodiment of the present invention.

A pneumatic device 51 shown in FIG. 7 includes an air channel 52 for guiding air, a fan 56 provided near an inlet 53 of the air channel 52 for causing air flow, and a filter 54 provided near an outlet 55 of the air channel 52 for removing dust in the air. The air channel 52 has a pressure take-off port 57 between the filter 54 and the fan 56 for taking the pressure of the air channel 52.

An air inflow side 58 of the filter 54 is defined as a primary side of the filter 54. An air outflow side 59 of the filter 54 is defined as a secondary side of the filter 54. Hollow arrow B1 indicates the flow of air at the primary side of the filter 54. Hollow arrow B2 indicates the flow of air at the secondary side of the filter 54.

The filter soil detecting device 60 includes a chamber 62 directly connected to the pressure take-off port 57 of the air channel 52, a lens 63 mounted on the distal end of the chamber 62, and a diaphragm 64 extended in the chamber 62 in parallel with the lens 63.

The chamber 62 has an inlet 67 as a connecting pipe for introducing the pressure of the air channel 52, and a vent 65 provided between the diaphragm 64 and the lens 63 for maintaining atmospheric pressure therebetween. The diaphragm 64 has a mark 66 provided on the surface opposite to the lens 63.

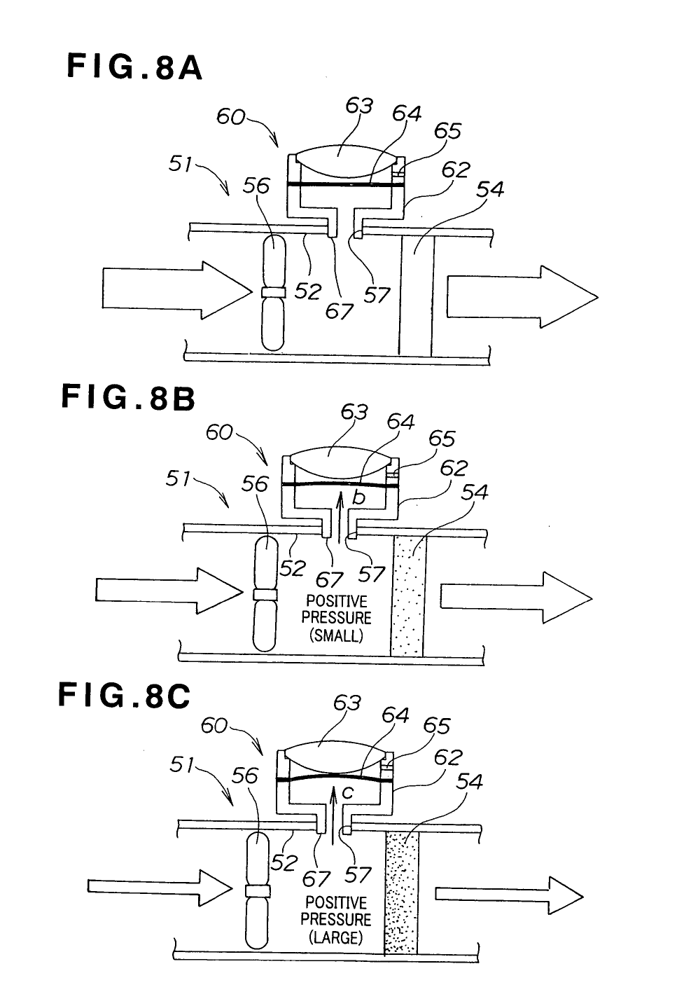

FIGS. 8A, 8B and 8C illustrate pressures in the air channel 52 and movements of the diaphragm 64 when the fan 56 is rotated at a maximum volume of air in the filter soil detecting device 60 of the fourth embodiment.

FIG. 8A illustrates a state in which no soiling or clogging of the filter 54 occurs. Pressure at the primary side of the filter 54 and pressure at the secondary side are substantially the same and have normal value. The diaphragm 64 can be kept horizontal.

FIG. 8B illustrates a state in which some soiling or clogging of the filter 54 occurs. The pressure at the primary side of the filter 54 becomes larger than normal value, forming a small positive pressure. The diaphragm 64 slightly curves as shown by arrow b.

FIG. 8C illustrates a state in which significant soiling or clogging of the filter 54 occurs. The pressure at the primary side of the filter 54 further becomes larger than normal value, forming a large positive pressure. The diaphragm 64 largely curves as shown by arrow c.

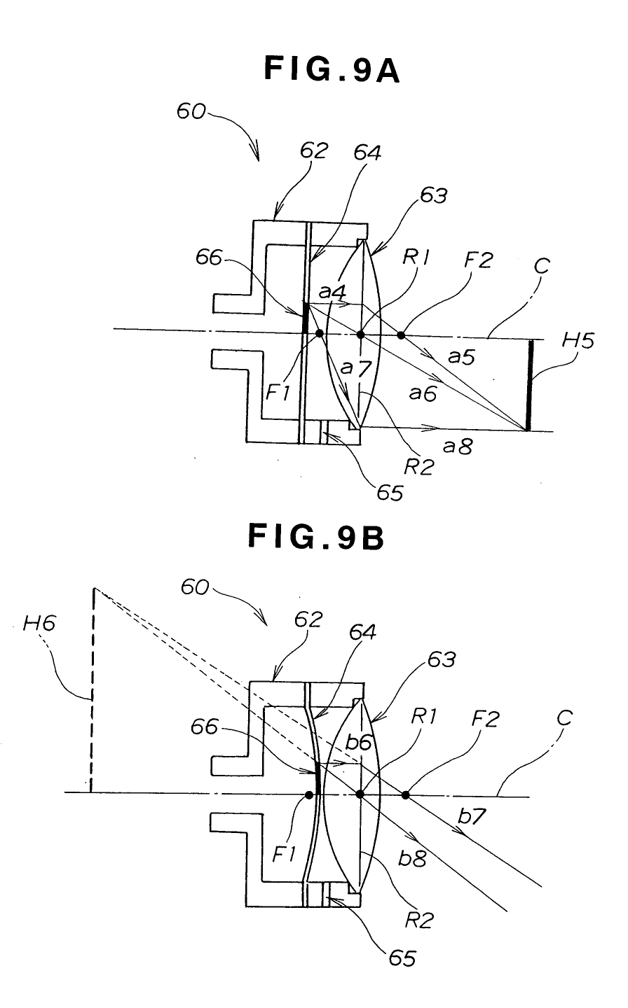

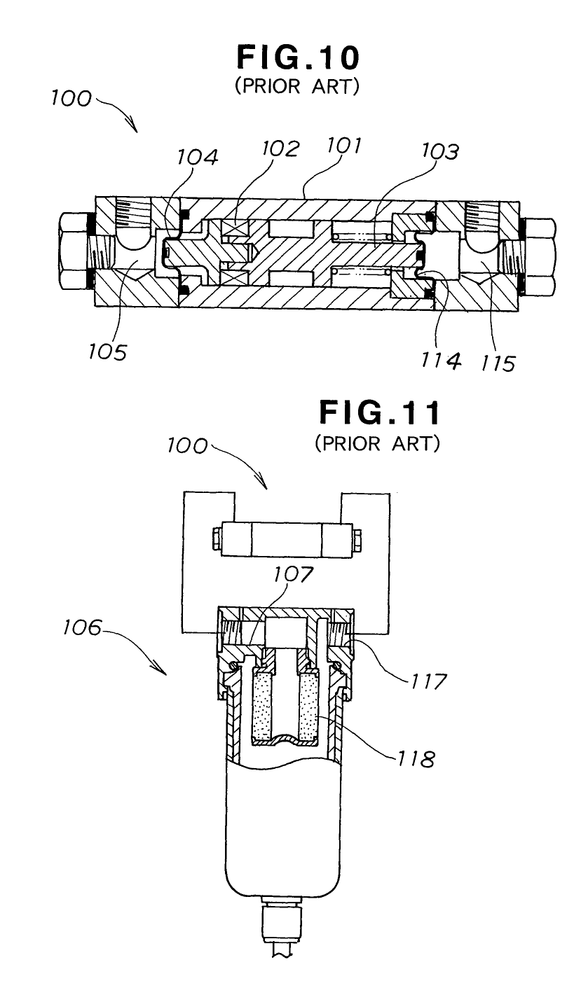

FIGS. 9A and 9B illustrate difference in the look of the mark 66 when the diaphragm 64 is looked in at from the outside of the lens 63, between a state in which no soiling or clogging of the filter 54 (see FIG. 7) occurs and a state in which soiling or clogging occurs in the filter soil detecting device 60 of the fourth embodiment.

In FIG. 9A, with Fl as the object-side focal point, F2 as the image-side focal point, C as the optical axis, R1 as the lens principal point and R2 as the lens principal plane, arrow a4 indicates light coming from the mark 66 in parallel with the optical axis C into the lens 63, arrow a5 indicates the light of a4 refracted at the lens principal plane R2 toward the image-side focal point F2, arrow a6 indicates light traveling from the mark 66 toward the lens principal point R1, arrow a7 indicates light coming from the mark 66 through the object-side focal point Fl, and arrow a8 indicates the light of arrow a7 refracted at the lens principal plane R2 to travel in parallel with the optical axis C. That is, a mark image (real image) H5 is formed at the gathering points of arrows a5, a6 and a8. The mark 66 can thus be seen as the mark image H5 from the outside of the lens 63.

In FIG. 9B, arrow b6 indicates light coming from the mark 66 into the lens 63 in parallel with the optical axis C, arrow b7 indicates the light of arrow b6 refracted at the lens principal plane R2 toward the image-side focal point F2, and arrow b8 indicates light coming from the mark 66 through the lens principal point R1. Since the mark 66 is located on the lens 63 side (inside) of the object-side focal point F1, the mark image (real image) H5 as shown in FIG. 9A is not formed. A mark image (virtual image) H6 is formed at the points of intersection of arrows b7 and b8 extended in the opposite directions. The mark 66 can thus be seen as the mark image H6 from the outside of the lens 63.

In the filter soil detecting device 60, when the mark image H5 can be seen, it is indicated that the filter 54 is free of soiling or clogging. When the mark image H6 can be seen, it is indicated that the filter 54 is significantly soiled or clogged and it is the time to replace or clean the filter 54.

The filter soil detecting device 60 for detecting increase in pressure at the primary side of the filter 54 above normal value when the filter 54 (see FIG. 7) is soiled, which filter soil detecting device 60 including the inlet (connecting pipe) 67 diverging from the air channel 52 (see FIG. 7) at the primary side of the filter 54, the chamber 62 provided at the distal end of the inlet 67, the lens 63 mounted on the distal end of the chamber 62, the diaphragm 64 extended in the chamber in parallel with the lens 63, the mark 66 provided on the surface of the diaphragm 64 opposite to the lens 63, and the vent 65 provided between the diaphragm 64 and the lens 63, utilizes the fact that the diaphragm 64 moves toward the lens 63 under the pressure at the primary side of the filter 54 to vary the mark image (H5, H6) seen through the lens 64 from outside, thereby to allow the detection of degree of soiling of the filter 54.

The diaphragm 64 can quickly move under the pressure at the primary side of the filter 54 and the mark 66 thereon can move with the movement of the diaphragm 64. The configuration to monitor the mark 66 though the lens 63 allows variation in the mark image (H5, H6) to be noticed even under small differential pressures. As a result, the state of clogging or soiling of the filter 54 can be easily determined.

The present disclosure relates to the subject matter of Japanese Patent Application No. 2002-192514, filed Jul. 1, 2002, the disclosure of which is expressly incorporated herein by reference in its entirety.

What is claimed is:

1. A filter soil detecting device for detecting, when a filter is soiled, decrease in pressure at a secondary side of said filter below normal value or increase in pressure at a primary side of said filter above normal value, said detecting device comprising:
a chamber provided in communication with a channel at the primary side or secondary side of said filter;
a lens mounted on the distal end of said chamber;
a diaphragm extended in said chamber in parallel with said lens;
a mark provided on the surface of said diaphragm opposite to said lens; and
a vent provided between said diaphragm and said lens,
said diaphragm being movable toward or away from said lens by pressure at the primary side or secondary side of said filter, varying the image of said mark seen through said lens from outside, thereby allowing the detection of degree of soiling of said filter.

2. A detecting device as set forth in claim 1 further comprising a connecting pipe connected to said channel in a diverging manner, in which said chamber is provided at the distal end of said connecting pipe.

3. A detecting device as set forth in claim 1 wherein said chamber is directly connected to said channel.

4. A detecting device as set forth in claim 1 further comprising a lens shade covering approximately half said lens.
